(19) United States
(12) Patent Application Publication
(10) Pub. No.: US 2017/0307177 A1
(43) Pub. Date: Oct. 26, 2017

(54) LIGHTING ASSEMBLY COMPRISING A SHUTTER THAT CONSISTS OF A PLURALITY OF APERTURES

(71) Applicant: OSRAM Opto Semiconductors GmbH, Regensburg (DE)

(72) Inventors: Stefan Groetsch, Bad Abbach (DE); Uli Hiller, Bad Abbach (DE); Michael Brandl, Mintraching (DE)

(21) Appl. No.: 15/518,019

(22) PCT Filed: Oct. 15, 2015
(86) PCT No.: PCT/EP2015/073939

§ 371 Date: Apr. 10, 2017

(30) Foreign Application Priority Data
Oct. 16, 2014 (DE) 10 2014 115 068.6

(51) Int. Cl. F21V 11/14; B60Q 1/14; F21S 8/10

(52) U.S. Cl. CPC F21V 11/14; F21S 48/1768; B60Q 1/14

(57) ABSTRACT

A light assembly includes a light source, and a micromechanical shutter arrangement having a two-dimensional arrangement of closable shutter openings, wherein at least one shutter opening has a rectangular shape with a length and a width, and the length is greater than the width. The light assembly may be configured as a headlamp for a motor vehicle.

### TECHNICAL FIELD

This disclosure relates to a lighting assembly.

### BACKGROUND

It is known to equip motor vehicles with front headlamps whose emitted light distribution adapts to a driving situation of the motor vehicle. Such systems are also referred to as adaptive front lighting systems or as active forward lighting (AFS). Such headlamps may, for example, comprise movable lenses to achieve improved illumination of a bend in the road when navigating such a bend. It is likewise known to configure such headlamps with a multiplicity of discretely driven light-emitting diode components that can be turned on or off individually depending on the geometry of the desired light distribution.

### SUMMARY

We provide a lighting assembly including a light source, and a micromechanical shutter arrangement having a two-dimensional arrangement of closable shutter openings, wherein at least one shutter opening has a rectangular shape with a length and a width, and the length is greater than the width.

### BRIEF DESCRIPTION OF THE DRAWINGS

FIG. 1 shows a lighting assembly.

FIG. 2 shows a sectional side view of a micromechanical shutter arrangement of the lighting assembly.

FIG. 3 shows a plan view of a part of the micromechanical shutter arrangement.

FIG. 4 shows a perspective representation of a target region to be illuminated on a road.

FIG. 5 shows a plan view of a part of a micromechanical shutter arrangement according to an alternative example.

FIG. 6 shows a sectional side view of a micromechanical shutter arrangement according to another example.

FIG. 7 shows a sectional side view of a micromechanical shutter arrangement according to another example.

FIG. 8 shows a plan view of a part of a light source of the lighting assembly.

### LIST OF REFERENCES

100 lighting assembly
110 light path
120 light
130 luminance gradient
200 light source
210 individual light sources
300 input optics
400 micromechanical shutter arrangement
401 horizontal direction
402 vertical direction
410 shutter screen
420 shutter opening
421 first shutter opening
422 second shutter opening
423 longitudinal direction
424 transverse direction
425 length
426 width
430 movable shutter
431 movement direction
440 transparent medium
450 converging lens
451 longitudinal axis
500 wavelength-converting element
510 individual wavelength-converting element
520 opaque barrier
600 optical imaging element
700 target region
701 horizontal direction
702 perpendicular directions
710 road

### DETAILED DESCRIPTION

A lighting assembly comprises a light source and a micromechanical shutter arrangement, having a two-dimensional arrangement of closable shutter openings. The micromechanical shutter arrangement may also be referred to as a digital microshutter or as a microshutter display. Advantageously, this lighting assembly makes it possible to modify the geometry of the light distribution of light emitted by this lighting assembly by individual opening and closing of the individual shutter openings of the micromechanical shutter arrangement of the lighting assembly. Since the closable shutter openings of the micromechanical shutter arrangement are arranged in a two-dimensional arrangement, the lighting assembly allows two-dimensional shaping of the geometry of the light distribution of the light emitted by the lighting assembly. In this case, variation of the geometry of the light distribution may advantageously be carried out with high resolution. Closing individual shutter openings of the micromechanical shutter arrangement of the lighting assembly advantageously allows a high contrast in the light distribution of the light emitted by the lighting assembly. The closable shutter openings of the micromechanical shutter arrangement of the lighting assembly may advantageously allow high switching speeds. The lighting assembly may be configured for operation in a wide temperature range of an ambient temperature.

At least one shutter opening of the micromechanical shutter arrangement has a rectangular shape with a length and a width. In this case, the length is greater than the width, preferably at least two times as great, particularly preferably at least three times as great. This means that the shutter openings of the shutter arrangement each have an elongate rectangular shape. This makes it possible to configure the micromechanical shutter arrangement with a higher resolution in the width direction than in the longitudinal direction. This makes it possible to modify the geometry of the light distribution of the light emitted by the lighting assembly with higher resolution in one spatial direction than in a spatial direction perpendicular thereto.

The lighting assembly may be configured as a headlamp for a motor vehicle. Advantageously, the lighting assembly therefore allows modification of the geometry of the light cone emitted by the headlamp of the motor vehicle into an environment of the motor vehicle. The lighting assembly configured as a headlamp therefore allows adaptation of the light emitted by the headlamp of the motor vehicle to a driving situation of the motor vehicle.

At least one of the shutter openings in an installation orientation of the lighting assembly may be greater in the horizontal direction than in the vertical direction. This makes it possible to modify the geometry of the light cone emitted by the headlamp of the motor vehicle more finely in the distance direction than in the transverse direction. The lighting assembly therefore allows accurate adaptation of the geometry of the light cone emitted by the headlamp of the motor vehicle to a multiplicity of different driving situations of the motor vehicle.

The shutter arrangement in the installation orientation of the lighting assembly may have a higher resolution in the vertical direction than in the horizontal direction. Advantageously, in this way as well the lighting assembly configured as a headlamp for a motor vehicle allows particularly accurate adaptation of the geometry of the light cone emitted by the headlamp of the motor vehicle in the distance direction and, therefore, adaptation to a multiplicity of different driving situations.

The micromechanical shutter arrangement may comprise a first shutter opening and a second shutter opening. In this case, the first shutter opening and the second shutter opening have different sizes. For example, a shutter opening arranged in the central region of the two-dimensional arrangement of closable shutter openings of the micromechanical shutter arrangement of the lighting assembly may have a smaller size than a shutter opening arranged in the outer region of the two-dimensional arrangement of closable shutter openings of the micromechanical shutter arrangement. In this case, the lighting assembly allows particularly fine variation of the geometry of the light distribution in the central region of a light distribution of light emitted by the lighting assembly.

The lighting assembly may comprise an arrangement of converging lenses, which is arranged before the micromechanical shutter arrangement in the light path of the lighting assembly. Arrangement of converging lenses may be used to guide light striking the micromechanical shutter arrangement to the closable shutter openings of the micromechanical shutter arrangement. In this way, only a small part of the light striking the micromechanical shutter arrangement of the lighting assembly is reflected or absorbed at regions of the micromechanical shutter arrangement arranged between the closable shutter openings of the micromechanical shutter arrangement so that the lighting assembly can advantageously have a particularly high efficiency.

The converging lenses may be configured as cylindrical lenses. This geometry of the converging lenses is suitable in particular when the closable shutter openings of the micromechanical shutter arrangement of the lighting assembly are shaped rectangularly.

The longitudinal axes of the converging lenses may be oriented parallel to the longitudinal directions of the shutter openings. Advantageously, the converging lenses therefore make it possible to concentrate light striking the micromechanical shutter arrangement of the lighting assembly into the shutter openings of the micromechanical shutter arrangement.

The light source may comprise a halogen incandescent lamp, a gas discharge lamp, a light-emitting diode and/or a laser diode. Advantageously, the light source of the lighting assembly can therefore allow energy-efficient generation of light with high brightness.

The light source may comprise a two-dimensional arrangement of individual light sources. Advantageously, this constitutes a simple possibility for increasing a maximum brightness of light emitted by the light source of the lighting assembly. The two-dimensional arrangement of individual light sources furthermore allows adaptation of the geometry of light emitted by the light source to an individual requirement.

The lighting assembly may be configured to switch at least some of the individual light sources on and off separately. Advantageously, this makes it possible to switch off individual light sources of the light source of the lighting assembly whose light would strike closed shutter openings of the micromechanical shutter arrangement of the lighting assembly to reduce an energy requirement of the lighting assembly.

The light source may be configured to generate a luminance gradient in the plane of the lighting assembly. In this case, the light source may, for example, comprise a two-dimensional arrangement of light-emitting diodes, and have one or more additional laser diodes that generates the luminance gradient.

The light source may comprise at least one light guide intended to guide light to the micromechanical shutter arrangement. Advantageously, this makes it possible to arrange the light source at a distance from the micromechanical shutter arrangement. In this way, the lighting assembly may be suitable for use in environments with limited available installation space.

The lighting assembly may comprise a wavelength-converting element to convert a wavelength of light emitted by the light source. The wavelength-converting element may, for example, be provided to convert light emitted by the light source with a wavelength in the blue or ultraviolet spectral range into light with a wavelength in the yellow spectral range.

The wavelength-converting element may be arranged behind the micromechanical shutter arrangement in the light path of the lighting assembly. Advantageously, the wavelength-converting element may in this case be supported and held by the micromechanical shutter arrangement of the lighting assembly. Advantageously, this allows a particularly simple and compact structure of the lighting assembly.

The wavelength-converting element may be subdivided into a two-dimensional arrangement of individual wavelength-converting elements. In this case, each closable shutter opening of the micromechanical shutter arrangement of the lighting assembly may be assigned to one individual wavelength-converting element of the wavelength-converting element.

The individual wavelength-converting elements of the wavelength-converting element may be separated from one another by opaque barriers. Advantageously, this prevents light that reaches one of the individual wavelength-converting elements through one of the closable shutter openings of the micromechanical shutter arrangement of the lighting assembly from being emitted into a neighboring individual wavelength-converting element, which is assigned to a different closable shutter opening of the micromechanical shutter arrangement. A high sharpness of the imaging caused by the micromechanical shutter arrangement of the lighting assembly is thereby advantageously achieved.

Each shutter opening of the shutter arrangement may be assigned to an individual element of the wavelength-converting element. Advantageously, it is thereby possible to achieve a high sharpness of imaging caused by the micromechanical shutter arrangement of the lighting assembly, and therefore a high sharpness of the geometry of the light distribution of the light emitted by the lighting assembly.

The lighting assembly may comprise an optical imaging element arranged after the shutter arrangement in the light path of the lighting assembly. The optical imaging element may, for example, comprise one or more optical lenses. The optical imaging element may be used to image the light distribution shaped by the micromechanical shutter arrangement of the lighting assembly into a target region in the environment of the lighting assembly. If the lighting assembly is configured as a headlamp for a motor vehicle, then the optical imaging element of the lighting assembly may, for example, be used to image the light distribution shaped by the shutter arrangement of the lighting assembly onto a road in the environment of the motor vehicle.

The above-described properties, features and advantages, as well as the way in which they are achieved, will become more clearly and readily comprehensible in conjunction with the following description of the examples, which will be explained in more detail in connection with the drawings.

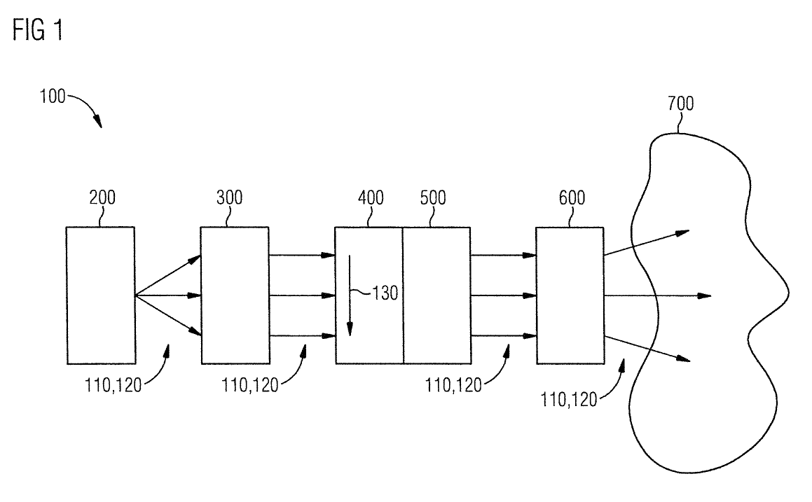

FIG. 1 shows a highly schematic view of a lighting assembly 100. The lighting assembly 100 may, for example, be used as a headlamp, in particular as a front headlamp, of a motor vehicle. The lighting assembly 100 in this case allows adaptive illumination of an environment of the motor vehicle, for example, adaptive illumination of a road section lying in front of the motor vehicle. The adaptive illumination may, for example, be adaptable to a driving situation of the motor vehicle. The adaptation of the illumination may, for example, comprise a horizontal and/or vertical displacement and/or size change and/or shape change of a region illuminated by the lighting assembly 100 in the environment of the motor vehicle. Adaptation of the illumination may, for example, be carried out depending on a driving speed of the motor vehicle, a bend navigation of the motor vehicle, a pitch or tilt movement of the motor vehicle, a type of road on which the motor vehicle is being driven, depending on the presence of other oncoming, preceding or following motor vehicles and/or depending on a brightness of an ambient light.

The lighting assembly 100 comprises a light source 200. The light source 200 generates light 120 that passes through the lighting assembly 100 along a light path 110 and is emitted by the lighting assembly 100 into a target region 700 to be illuminated by the lighting assembly 100. The light source 200 may, for example, comprise one or more halogen incandescent lamps, one or more gas discharge lamps, one or more light-emitting diodes and/or one or more laser diodes.

The lighting assembly 100 comprises input optics 300 arranged after the light source 200 of the lighting assembly 100 in the light path 110 of the lighting assembly 100. If the light 120 generated by the light source 200 of the lighting assembly 100 is emitted divergently by the light source 200, then the input optics 300 may be used to collimate the light 120 at least partially. In this case, the input optics 300 may, for example, comprise one or more optical lenses, in particular one or more converging lenses. The input optics 300 may also comprise one or more light guides to guide the light 120 generated by the light source 200 to components of the lighting assembly 100 arranged after the input optics 300. The light guide or the light guides may, for example, be configured as glass fibers and/or as optical tapers. The input optics 300 may, however, be entirely omitted.

A micromechanical shutter arrangement 400 is arranged after the input optics 300 in the light path 110 of the lighting assembly 100. The micromechanical shutter arrangement 400 may also be referred to as a digital microshutter or as a microshutter display. The light 120 generated by the light source 200 and guided by the input optics 300 to the micromechanical shutter arrangement 400 strikes the micromechanical shutter arrangement 400 of the lighting assembly 100. The micromechanical shutter arrangement 400 transmits only an adjustable part of the light 120 and, therefore, induces shaping of the geometry of the light distribution emitted by the lighting assembly 100 into the target region 700.

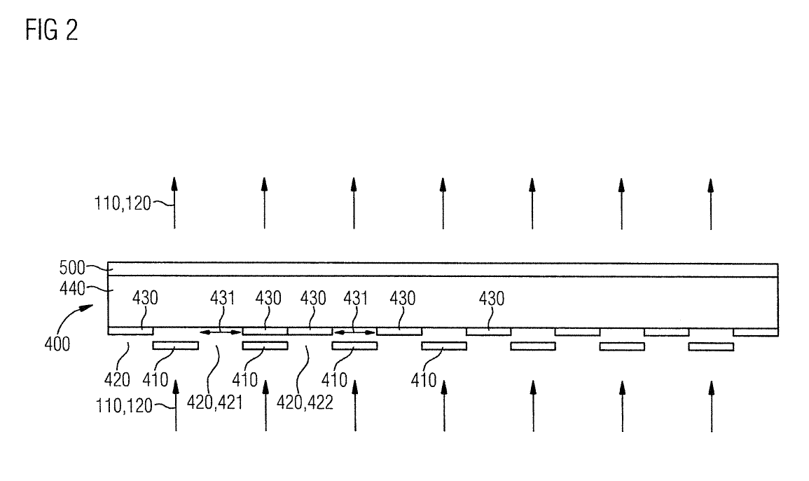

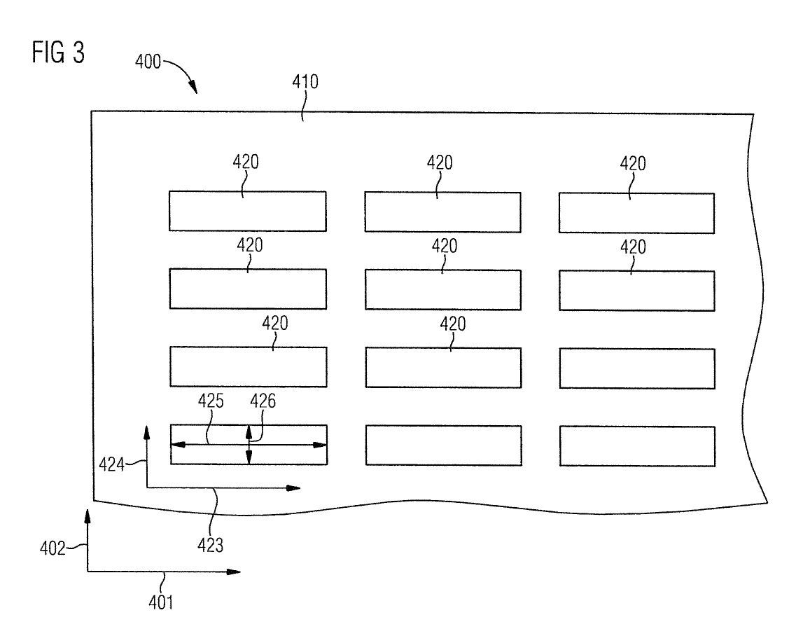

FIG. 2 shows a schematic sectional side view of the micromechanical shutter arrangement 400. The micromechanical shutter arrangement 400 comprises a shutter screen 410 oriented essentially perpendicularly to the direction of the light path 110 of the lighting assembly 100. FIG. 3 shows a schematic view of a part of the shutter screen 410. The shutter screen 410 extends in a horizontal direction 401 and in a vertical direction 402. The horizontal direction 401 and in a vertical direction 402 are oriented perpendicularly to the direction of the light path 110.

The shutter screen 410 comprises a two-dimensional arrangement of closable shutter openings 420. The shutter openings 420 are preferably arranged in a regular grid arrangement, for example, in a rectangular grid. The shutter openings 420 are preferably arranged along a grid with axes parallel to the horizontal direction 401 and the vertical direction 402.

In the example shown in FIG. 3, each shutter opening 420 has a rectangular shape with edges parallel to a longitudinal direction 423 and to a transverse direction 424 oriented perpendicularly to the longitudinal direction 423. The longitudinal direction 423 is therefore preferably oriented parallel to the horizontal direction 401 of the shutter screen 410. The transverse direction 424 is then oriented parallel to the vertical direction 402 of the shutter screen 410.

Each shutter opening 420 has a length 425 in the longitudinal direction 423. In the transverse direction 424, each shutter opening 420 has a width 426. In the example represented, the length 425 is greater than the width 426, preferably at least two times as great, particularly preferably even at least three times as great. The shutter openings 420 are therefore configured as rectangular openings oriented in the horizontal direction 401.

The rectangular shape of the shutter openings 420 of the shutter screen 410 makes it possible for the shutter screen 410 to have more shutter openings 420 per unit length in the vertical direction 402 than in the horizontal direction 401. Resolution of the shutter openings 420 of the shutter screen 410 is therefore higher in the vertical direction 402 than in the horizontal direction 401. It is, however, also possible to configure the micromechanical shutter arrangement 400 with an equal number of shutter openings 420 per unit length in the horizontal direction 401 and in the vertical direction 402. The shutter openings 420 may also be configured with a square shape, a circular disk shape or another shape.

Each shutter opening 420 in the shutter screen 410 of the micromechanical shutter arrangement 400 is respectively assigned to a movable shutter 430. The movable shutters 430 are used to individually open or close the shutter openings 420 in the shutter screen 410 of the micromechanical shutter arrangement 400. To this end, each movable shutter 430 can be moved in a movement direction 431. The movement direction 431 may, for example, be oriented parallel to the transverse direction 424 of the shutter openings 420.

In the schematic representation of FIG. 2, the movable shutters 430 are arranged behind the shutter screen 430 comprising the shutter openings 420 in the direction of the light path 110. It is, however, likewise possible to arrange the movable shutters 430 before the shutter screen 410 in the direction of the light path 110.

Each shutter opening 420 in the shutter screen 410 of the micromechanical shutter arrangement 400 can be opened or closed by displacing the movable shutter 430 assigned to the respective shutter opening 420 along the movement direction 431. In the schematic representation of FIG. 2, a first shutter opening 420, 421 is represented in the opened state. A second shutter opening 420, 422 is shown in the closed state. Light 120 reaching the first shutter opening 420, 421 in the shutter screen 410 of the micromechanical shutter arrangement 400 in the direction of the light path 110 can cross the micromechanical shutter arrangement 400 through the first shutter opening 420, 421. Light 120 reaching the second shutter opening 420, 422 in the shutter screen 410 of the micromechanical shutter arrangement 400 in the direction of the light path 110 is reflected or absorbed by the movable shutter 430 of the second shutter opening 420, 422, and is therefore prevented from passing through the micromechanical shutter arrangement 400.

By individual opening and closing of the two-dimensional arrangement of closable shutter openings 420 of the micromechanical shutter arrangement 400, a two-dimensional image pattern in the plane perpendicular to the direction of the light path 110 can be imposed on the light 120 traveling through the micromechanical shutter arrangement 400 in the direction of the light path 110.

To open and close the movable shutters 430, the micromechanical shutter arrangement may have one or more micromechanical actuators per movable shutter 430. In the case of only one actuator per movable shutter 430, the movement of the movable shutter 430 in a movement direction may be carried out by the actuator, and in the opposite movement direction by a spring-elastic restoring force. When there are two actuators, the movement in both opposite movement directions may respectively be driven by an actuator. This offers the advantage of increased temperature independence of the movement of the movable shutters 430 of the micromechanical shutter arrangement 400.

In the example schematically represented in FIG. 1, the lighting assembly 100 has a wavelength-converting element 500. The wavelength-converting element 500 is intended to convert at least a part of the light 120 emitted by the light source 200 into light of a different wavelength. In this way, the light 120 emitted into the target region 700 by the lighting assembly 100 can have a different light color than the light 120 generated by the light source 200 of the lighting assembly 100. For example, the wavelength-converting element 500 may be configured to convert light with a wavelength in the blue or ultraviolet spectral range into yellow light. A mixture of unconverted light and light converted by the wavelength-converting element 500 may have a white color impression. If the light color of the light 120 generated by the light source 200 of the lighting assembly 100 corresponds to the desired light color of the light 120 emitted by the lighting assembly 100 in the target region 700, then the wavelength-converting element 500 may be omitted.

In the example schematically represented in FIGS. 1 and 2, the wavelength-converting element 500 mechanically connects to the micromechanical shutter arrangement 400 arranged before the wavelength-converting element 500 in the light path 110. The micromechanical shutter arrangement 400 comprises a transparent medium 440, for example, a glass plate on one side of which the shutter screen 410 comprising the closable shutter openings 420 is arranged. The wavelength-converting element 500 is arranged on the opposite side of the transparent medium 440. To this end, for example, the wavelength-converting element 500 may be arranged on the transparent medium 440 by a deposition method.

It is, however, likewise possible to arrange the wavelength-converting element 500 on the other side in the light path 110 of the lighting assembly 100. In particular, the wavelength-converting element 500 may be arranged before the micromechanical shutter arrangement 400 in the direction of the light path 110. For example, it is possible to arrange the wavelength-converting element 500 immediately behind the light source 200 of the lighting assembly 100.

The lighting assembly 100 comprises an optical imaging element 600 arranged after the micromechanical shutter arrangement 400 and the wavelength-converting element 500 in the direction of the light path 110. The optical imaging element 600 is intended to image the light 120 passing through the micromechanical shutter arrangement 400 along the light path 110 into the target region 700. To this end, for example, the optical imaging element 600 may have one or more optical lenses and/or one or more mirrors.

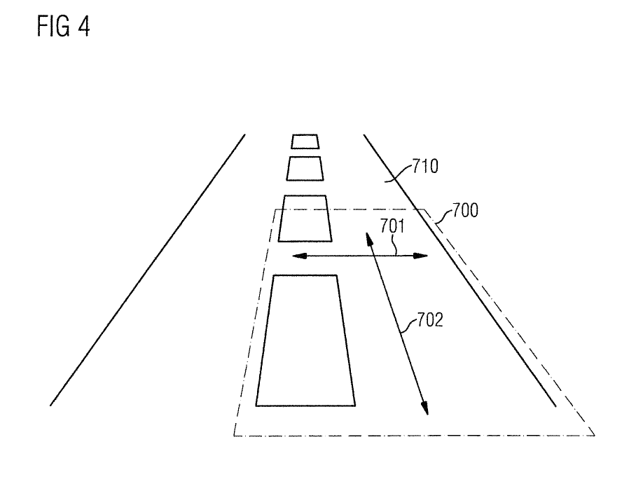

FIG. 4 shows a schematic perspective representation of the target region 700 in an example in which the lighting assembly 100 is configured as a headlamp for a motor vehicle. The target region 700 is formed by a section, of a road 710 along which the motor vehicle is traveling, which lies in front of the motor vehicle in the driving direction and is intended to be illuminated by the lighting assembly 100 configured as a headlamp. The target region 700 extends in a horizontal direction 701 oriented transversely to the driving direction and in a perpendicular direction 702 oriented parallel to the driving direction, which may also be referred to as the distance direction.

Preferably, the optical imaging element 600 of the lighting assembly 100 is configured such that the horizontal direction 401 of the micromechanical shutter arrangement 400 in the installation orientation of the lighting assembly 100 is imaged onto the horizontal direction 701 of the target region 700, and the vertical direction 402 of the micromechanical shutter arrangement 400 is imaged onto the perpendicular direction 702 of the target region 700. If the micromechanical shutter arrangement 400 has a higher resolution, i.e., a greater number of shutter openings 420 per length section of the shutter screen 410, in the vertical direction 402 than in the horizontal direction 401, then the shape of the light pattern emitted into the target region 700 by the lighting assembly 100 can be adjusted more finely in the perpendicular direction 702, i.e., in the distance direction, than in the horizontal direction 701 of the target region 700.

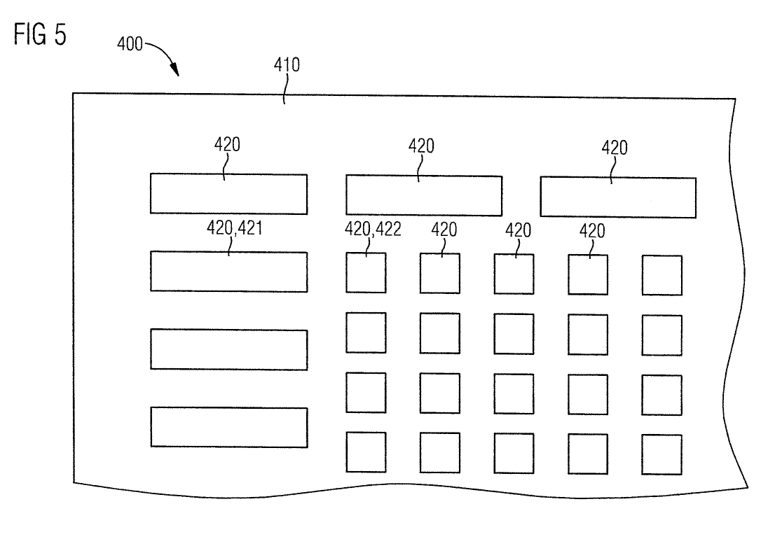

FIG. 5 shows a schematic representation of a view of a part of the side of the micromechanical shutter arrangement 400 facing toward the input optics 300 of the lighting assembly 100 in an alternative example. The shutter screen 410 of the micromechanical shutter arrangement 400, comprising the two-dimensional arrangement of closable shutter openings 420, can be seen.

In contrast to the example of the micromechanical shutter arrangement 400 as represented schematically in FIG. 3, in the example of the micromechanical shutter arrangement 400 as shown in FIG. 5 not all the shutter openings 420 have the same shape and size. The first shutter opening 420, 421, arranged in the edge region of the two-dimensional arrangement of closable shutter openings 420, has a rectangular shape and corresponds in shape and size to the shutter openings 420 of the micromechanical shutter arrangement 400 in the example represented in FIG. 3. Conversely, the second shutter opening 420, 422, arranged closer to the middle of the two-dimensional arrangement of closable shutter openings 420, has a square shape and a smaller area than the first shutter opening 420, 421.

This provides the possibility of arranging the shutter openings 420 in the region around the middle of the two-dimensional arrangement of closable shutter openings 420 with a higher resolution than in the edge region of the two-dimensional arrangement of closable shutter openings 420. In the central region of the two-dimensional arrangement of closable shutter openings 420, more individual shutter openings are therefore arranged per unit area of the shutter screen 410 than in the edge region of the two-dimensional arrangement of closable shutter openings 420.

The example of the micromechanical shutter arrangement 400 as shown in FIG. 5 offers the advantage that the higher resolution of the micromechanical shutter arrangement 400 in the central region allows more finely resolved influencing of the geometry of the light distribution emitted by the lighting assembly 100 into the target region 700 in the central region of the target region 700. Of course, it is possible to increase the resolution of the micromechanical shutter arrangement 400 in another region, for example, an edge region instead of in its central region.

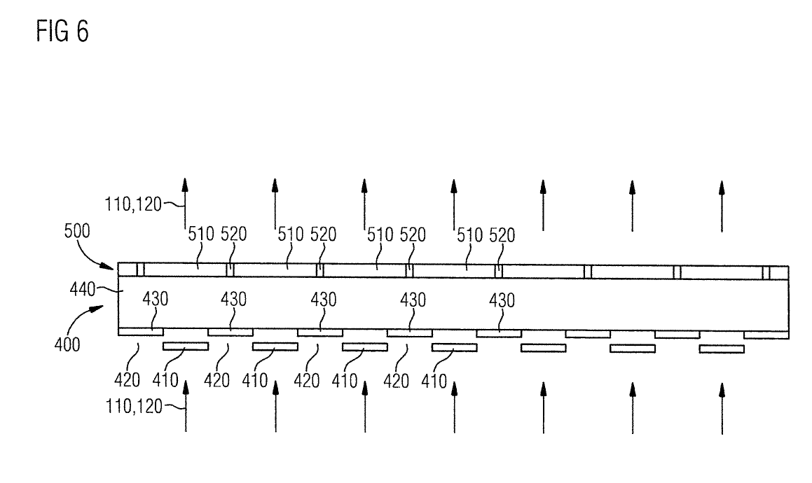

FIG. 6 shows a schematic sectional side view of the micromechanical shutter arrangement 400 and of the wavelength-converting element 500 according to another alternative example of the lighting assembly 100. In the example shown in FIG. 6, the wavelength-converting element 500 is subdivided into a two-dimensional arrangement of individual wavelength-converting elements 510. In this case, each shutter opening 420 in the shutter screen 410 of the micromechanical shutter arrangement 400 is assigned to an individual wavelength-converting element 510 of the wavelength-converting element 500 such that the assigned individual wavelength-converting element 510 is in each case arranged behind the assigned shutter opening 420 in the direction of the light path 110. The individual wavelength-converting elements 510 of the wavelength-converting element 500 are separated from one another by opaque barriers 520.

The wavelength-converting element 500 subdivided into the individual wavelength-converting elements 510 offers the advantage that light 120 scattered in one of the individual wavelength-converting elements 510 cannot cross the opaque barriers 520 arranged between the individual wavelength-converting elements 510 into neighboring individual wavelength-converting elements 510. This ensures that light 120 that has passed through an opened shutter opening 420 of the micromechanical shutter arrangement 400 into one of the individual wavelength-converting elements 510 is not scattered into a neighboring individual wavelength-converting element 510, to which a closed shutter opening 420 of the micromechanical shutter arrangement 400 is assigned. In this way, an image pattern generated by the micromechanical shutter arrangement 400 in the plane perpendicular to the direction of the light path 110 can be maintained with high sharpness even after the light 120 has passed through the wavelength-converting element 500.

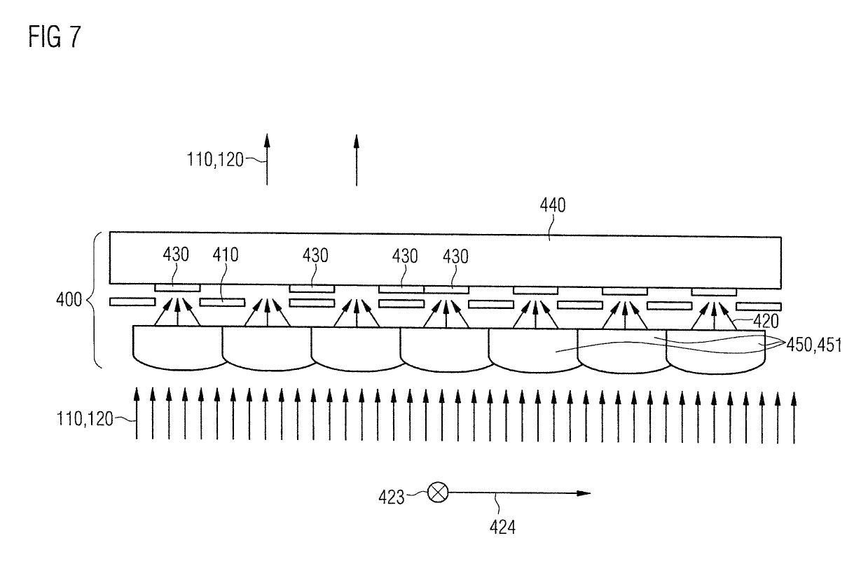

FIG. 7 shows a schematic sectional side view of the micromechanical shutter arrangement 400 according to another alternative example of the lighting assembly 100. The example of the micromechanical shutter arrangement 400 as shown in FIG. 7 differs from the example of the micromechanical shutter arrangement 400 as shown in FIG. 2 in that a multiplicity of converging lenses 450 are arranged before the shutter screen 410 of the micromechanical shutter arrangement 400 in the direction of the light path 110. The converging lenses 450 concentrate light 120 reaching the micromechanical shutter arrangement 400 in the direction of the light path 110 at least partially toward the shutter openings 420 in the shutter screen 410 of the micromechanical shutter arrangement 400. In this way, only a relatively small part of the light 120 generated by the light source 200 of the lighting assembly 100 reaches the regions of the shutter screen 410 arranged between the shutter openings 420 of the shutter screen 410, where it is absorbed or reflected. The usable fraction of the light 120 generated by the light source 200 of the lighting assembly 100 can thereby be increased.

In the example represented in FIG. 7, the converging lenses 451 are configured as cylindrical lenses. Longitudinal axes (symmetry axes) 451 of the converging lenses 450 configured as cylindrical lenses are in this case oriented parallel to the longitudinal directions 423 of the shutter openings 420. This configuration of the converging lenses 450 makes it possible that only one converging lens 450 needs to be provided per row of shutter openings 420 oriented in the longitudinal direction 423.

The light 120 reaching the converging lenses 450 from the input optics 300 of the lighting assembly may be directed with different strengths in the horizontal direction 401 and in the vertical direction 402 of the micromechanical shutter arrangement 400, i.e., it may have a differently large divergence. In this case, the longitudinal axes 451 of the converging lenses 450 configured as cylindrical lenses are preferably oriented parallel to the direction of the higher divergence of the light 120.

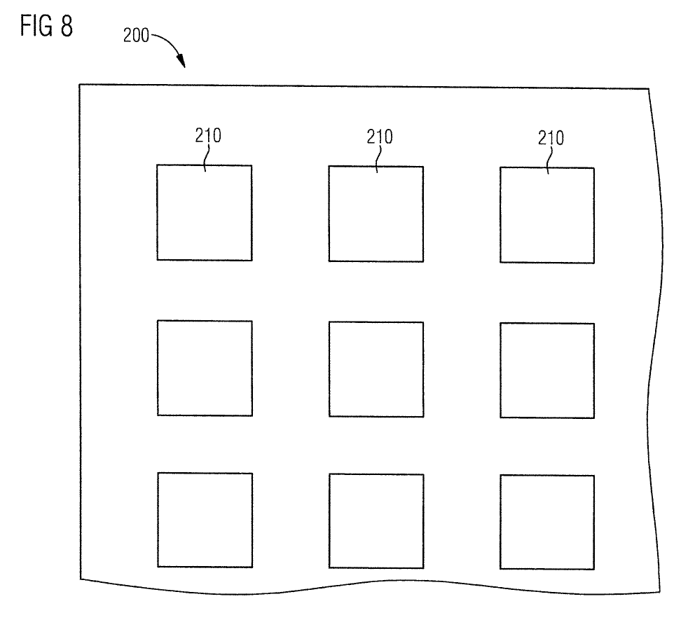

FIG. 8 shows a schematic view of a part of the light source 200 according to one example of the lighting assembly 100. In the example shown in FIG. 8, the light source 200 comprises a two-dimensional arrangement of individual light sources 210. The two-dimensional arrangement of individual light sources 210 is oriented perpendicularly to the direction of the light path 110. The individual light sources 210 are preferably arranged in a regular two-dimensional grid, for example, in a two-dimensional rectangular grid. Each individual light source 210 of the light source 200 may comprise one or more halogen incandescent lamps, one or more gas discharge lamps, one or more light-emitting diodes and/or one or more laser diodes. For example, each individual light source 210 of the light source 200 may comprise one light-emitting diode.

Preferably, at least some of the individual light sources 210 of the light source 200 may be turned on and off separately from one another. If all the shutter openings 420 are closed in a subregion of the shutter screen 410 of the micromechanical shutter arrangement 400 of the lighting assembly 100, then one or more of the individual light sources 210 may be turned off in a subregion of the light source 200 assigned to this subregion of the shutter screen 410 of the micromechanical shutter arrangement 400. In this way, an energy saving may be made possible.

The configuration of the light source 200 with a two-dimensional arrangement of individual light sources 210 may also make it possible to generate a luminance gradient 130 oriented perpendicularly to the direction of the light path 110 at the position of the micromechanical shutter arrangement 400 of the lighting assembly 100, as is represented schematically in FIG. 1. To generate the luminance gradient 130, the light source 200 may, for example, comprise a further laser system in addition to the two-dimensional arrangement of individual light sources 210.

Our assemblies have been illustrated and described in detail with the aid of the preferred examples. This disclosure is not, however, restricted to the examples disclosed. Rather, other variants may be derived therefrom by those skilled in the art without departing from the protective scope of the appended claims.

This application claims priority of DE 10 2014 115 068.6, the subject matter of which is incorporated herein by reference.

1-19. (canceled)

20. A lighting assembly comprising:
a light source, and
a micromechanical shutter arrangement having a two-dimensional arrangement of closable shutter openings,
wherein at least one shutter opening has a rectangular shape with a length and a width, and
the length is greater than the width.

21. The lighting assembly according to claim 20, wherein the lighting assembly is configured as a headlamp for a motor vehicle.

22. The lighting assembly according to claim 21, wherein at least one of the shutter openings in an installation orientation of the lighting assembly is greater in a horizontal direction than in a vertical direction.

23. The lighting assembly according to claim 22, wherein the shutter arrangement in the installation orientation of the lighting assembly has a higher resolution in the vertical direction than in the horizontal direction.

24. The lighting assembly according to claim 20, wherein the micromechanical shutter arrangement comprises a first shutter opening and a second shutter opening, and
the first shutter opening and the second shutter opening have different sizes.

25. The lighting assembly according to claim 20, further comprising an arrangement of converging lenses arranged before the micromechanical shutter arrangement in the light path of the lighting assembly.

26. The lighting assembly according to claim 25, wherein the converging lenses are configured as cylindrical lenses.

27. The lighting assembly according to claim 26, wherein longitudinal axes of the converging lenses are oriented parallel to the longitudinal directions of the shutter openings.

28. The lighting assembly according to claim 20, wherein the light source comprises a halogen incandescent lamp, a gas discharge lamp, a light-emitting diode and/or a laser diode.

29. The lighting assembly according to claim 20, wherein the light source comprises a two-dimensional arrangement of individual light sources.

30. The lighting assembly according to claim 29, wherein the lighting assembly is configured to switch at least some of individual light sources on and off separately.

31. The lighting assembly according to claim 20, wherein the light source is configured to generate a luminance gradient in the plane of the shutter arrangement.

32. The lighting assembly according to claim 20, wherein the light source comprises at least one light guide that guides light to the micromechanical shutter arrangement.

33. The lighting assembly according to claim 20, wherein the lighting assembly comprises a wavelength-converting element that converts a wavelength of light emitted by the light source.

34. The lighting assembly according to claim 33, wherein the wavelength-converting element is arranged behind the micromechanical shutter arrangement in the light path of the lighting assembly.

35. The lighting assembly according to claim 33, wherein the wavelength-converting element is subdivided into a two-dimensional arrangement of individual wavelength-converting elements.

36. The lighting assembly according to claim 35, wherein the individual wavelength-converting elements are separated from one another by opaque barriers.

37. The lighting assembly according to claim 35, wherein each shutter opening of the shutter arrangement is assigned to an individual element of the wavelength-converting element.

38. The lighting assembly according to claim 20, wherein the lighting assembly comprises an optical imaging elements arranged after the shutter arrangement in the light path of the lighting assembly.
